(19) United States
(12) Patent Application Publication
(10) Pub. No.: US 2004/0039709 A1
(43) Pub. Date: Feb. 26, 2004

(54) Method of payment

(76) Inventors: Petri Pirhonen, Oulu (FI); Petri Hyyppa, Oulu (FI)

Correspondence Address: PERMAN & GREEN, LLP, 425 Post Road, Fairfield, CT, 06824, US

(21) Appl. No.: 10/348,709

(22) Filed: Jan. 22, 2003

(30) Foreign Application Priority Data
Jan. 23, 2002 (GB) 0201504.8

(51) Int. Cl. G06F 17/60

(52) U.S. Cl. 705/72

(57) ABSTRACT

The invention provides a method for facilitating payments in a mobile device comprising providing the mobile device with a payment certificate. The payment certificate comprises identification information relating to the mobile device.

### FIELD OF THE INVENTION

The present invention relates to a method of payment and in particular, but not exclusively, to a method of payment using a mobile terminal.

### BACKGROUND OF THE INVENTION

Techniques for mobile e-commerce are known and are being developed. It has been proposed to carry out e-commerce transactions using a mobile device such as a mobile telephone or terminal in order to purchase goods or services at a local sales terminal.

In such transactions, there is typically a wireless communication between the mobile device and, for example, a point-of-sale terminal in a store, or other type of retail device such a vending machine or ticket machine. The mobile device and the point-of-sale terminal communicate to exchange relevant data to negotiate the purchase of goods or services, including the communication of the payment means from the mobile device to the point of sale terminal.

In such transactions, the payment information transferred from the mobile terminal to the point-of-sale terminal is authorised by a digital signature applied to the payment information. A typical transaction effectively provides a credit card payment to the point-of-sale terminal with a digital signature.

One problem with such payments, is that a connection may need to be made to a third party server in order to verify the transaction. This requires the point-of-sale terminal or the like to be connected to a communication network via a wired or wireless connection. This can be disadvantageous.

Where the point-of-sale terminal is not connected to a server or the like which authenticates the transaction, fraudulent transactions can be a problem.

### SUMMARY OF THE INVENTION

Embodiments of the present invention aim to address one or more of the above problems.

According to an aspect of the present invention, there is provided a method for facilitating payments in a mobile device comprising providing the mobile device with a payment certificate, said payment certificate comprising identification information relating to said mobile device.

According to a second aspect of the present invention, there is provided a method for facilitating payments in a mobile device comprising providing the mobile device with a payment certificate, said payment certificate containing information relating to said mobile device.

According to a third aspect of the present invention, there is provided a payment system comprising a mobile device and a sale device, said mobile device and said sale device comprising means for establishing a connection therebetween, said mobile device being arranged to store a payment certificate comprising identification information relating to said device, said payment certificate being sent in use to said sale device, said sale device comprising means for validating the certificate and means for authorising a payment in dependence on the results of said validation by said validation means.

According to a further aspect of the present invention, there is provided a mobile device for making a payment, said device comprising storage means, said storage means storing a payment certificate comprising information identifying said device.

### BRIEF DESCRIPTION OF DRAWINGS

For a better understanding of the present invention and as to how the same may be carried into effect, reference will now be made by way of example to the accompanying drawings in which:

FIG. 1 illustrates a connection scenario between a user and a financial services provider;

FIG. 2 illustrates the main elements of a mobile terminal for implementing the present invention;

FIG. 3 illustrates a connection between a mobile device and a vending machine;

FIG. 4 illustrates a flow chart showing the steps for receiving a certificate from an issuer; and

FIG. 5 shows the data flow between a mobile device and a vending machine during a vending operation.

### DESCRIPTION OF PREFERRED EMBODIMENTS OF THE INVENTION

The present invention is described hereinafter with reference to a particular set of embodiments. However, the invention is not limited to such embodiments. The invention is particularly described by way of reference to a particular wireless network arrangement.

A particular embodiment of the present invention is now described with reference to the flow diagram of FIG. 4. The flow diagram of FIG. 4 represents an exemplary embodiment and, as will be further described hereinbelow, modifications and refinements to the method of the flow diagram of FIG. 4 are permitted by the present invention.

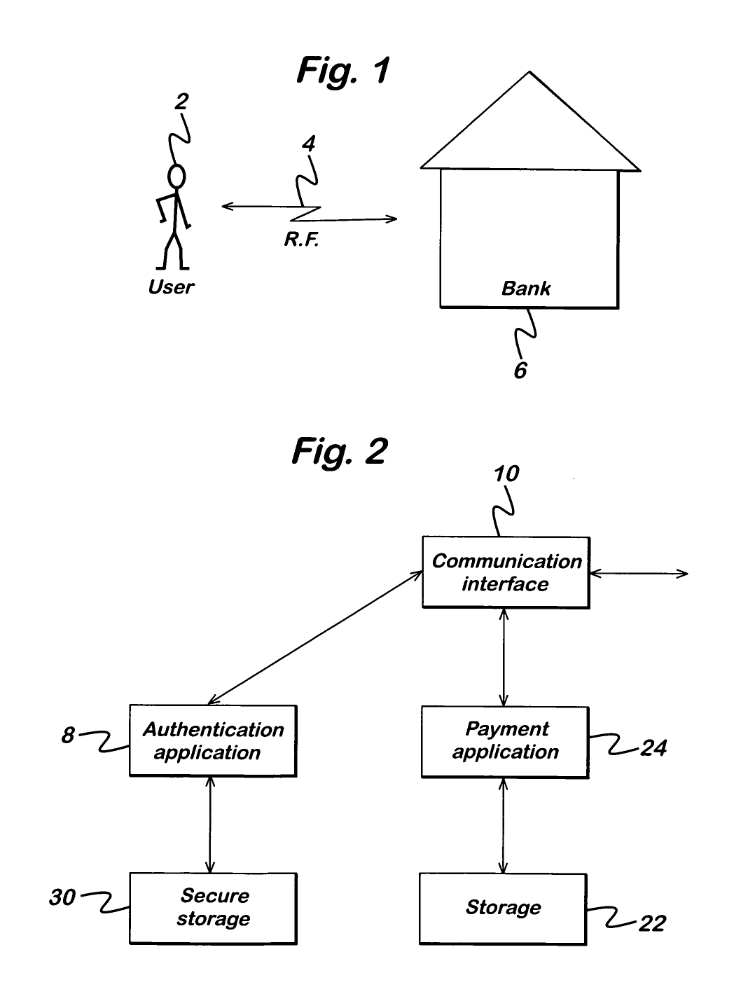

In a first step S1, a secure connection is created between the mobile terminal and a certificate issuer. Referring to FIG. 1, the user is associated with a mobile terminal. This mobile terminal may be a telephone, a PDA device (personal digital assistant), portable computer or any other suitable device. The user makes a connection with the certificate issuer via a wired connection, a radio frequency connection, an infrared connection, a Bluetooth connection or any other suitable connection. The connection between the mobile terminal of the user and the certificate issuer may be via a telecommunications network. For example, the mobile terminal may communicate with its base station. The base station is connected to the remainder of the wireless networks and in a known way, a connection is made via the backbone of the wireless network to the certificate issuer. The certificate issuer may be connected to a wired network. Alternatively, a direct connection can be made between the mobile terminal and the certificate issuer. The connection may be established on a GSM wireless telephony system such as CSD or GPRS. However, the implementation of such a link is not important to the invention and any technology may be used in embodiments of the invention. The link between the terminal and the certificate is preferably a secure link.

The certificate can be provided alternatively or additionally, by any type of financial institution, such as a bank or credit agency, or may be provided by any other suitable service provider. The certificate is preferably short lived and lasts for a few weeks only. However in alternative embodiments of the invention the certificate may last longer or shorter than a few weeks and may be very long lived (for example last for a few months or years) or very short lived ( for example last for a few hours or days).

Thus, as seen in FIG. 1, the user 2 communicates with the bank 6 via a radio frequency link designated 4 in FIG. 1. Thus, in the preferred embodiment, the mobile terminal of the user establishes a mobile telephone connection to the certificate issuer in order to download the certificate. This is now described in more detail hereinafter.

In step S2, the mobile terminal sends its one or more device identity to the certificate issuer. This can be for example, if the user has a blue tooth capable mobile telephone, the Blue tooth identity, the telephone number of the user, the mobile station identity number, the device public key, the international mobile station equipment identity IKEA, or any other identity number or name associated with the terminal.

In step S3, the certificate issuer issues the certificate to the mobile terminal. The received device identity is optionally included in the certificate. Preferably the device identity is encrypted using any suitable encryption method. Additionally, the certificate contains the payment card number as an identity for payment clearing purposes. This can be regarded as the number of the certificate in some embodiments of the invention. This number is optionally associated with a corresponding PIN (personal identification number) code. In particular an algorithm may be use the payment card identity and/or the mobile terminal identity to generate a PIN code. Additionally or alternatively, the certificate contains the period for which the certificate is valid. The certificate may be digitally signed by the certificate issuer using known techniques.

In step S4, the certificate issuer send the certificate to the terminal over the connection. The mobile terminal receives the certificate and stores it in any suitable store.

In step S5, the user receives the PIN code. The PIN code is sent separately to the certificate. The PIN code can be sent to the user by mail or the like. It is preferable, but not necessarily essential, that the PIN code be sent to the user via a different route to the certificate. This step can be omitted in some embodiments of the present invention.

The short lived certificate can be downloaded by the user for example, once a month, once a week or more or less frequently as required. Where a PIN code is used, the PIN code can remain the same or the PIN code can change each time the certificate changes.

Reference is made to FIG. 2 which illustrates in block diagram form the main functional elements of the mobile terminal or device required for implementing embodiments of the present invention. The operation of a mobile terminal device for e-commerce techniques will be familiar to one skilled in the art. Only such detail of the implementation of the mobile terminal or device is described herein as is necessary to understand the present invention.

Referring to FIG. 2, the mobile device includes, a communication interface block 10, a payment application 24, a secure memory or storage 30, a non-secure memory or storage 22 and an authentication application 8. The payment application 24 contains the payment logics of the mobile device and has access to the certificate wherever its is stored.

The authentication application 8 offers authentication services to the device. The authentication application has access to the memory 30 which is a secure memory area. This contains sensitive information such as the private key, the IKEA or other security related information. The secure memory is only accessible to the authentication application 8 in preferred embodiments of the invention.. In preferred embodiments of the present invention, it is not possible for a user of the user equipment to access the memory 30. The secure store can take any suitable form. For example, the IKEA can be hard coded or the private key can be stored in any suitable memory store. The certificate can be stored in the secure store 30 or the normal store 22. The communication interface allows communications between the payment application 24 and the authentication application 8. The interface also allows communications with a vending machines or the like.

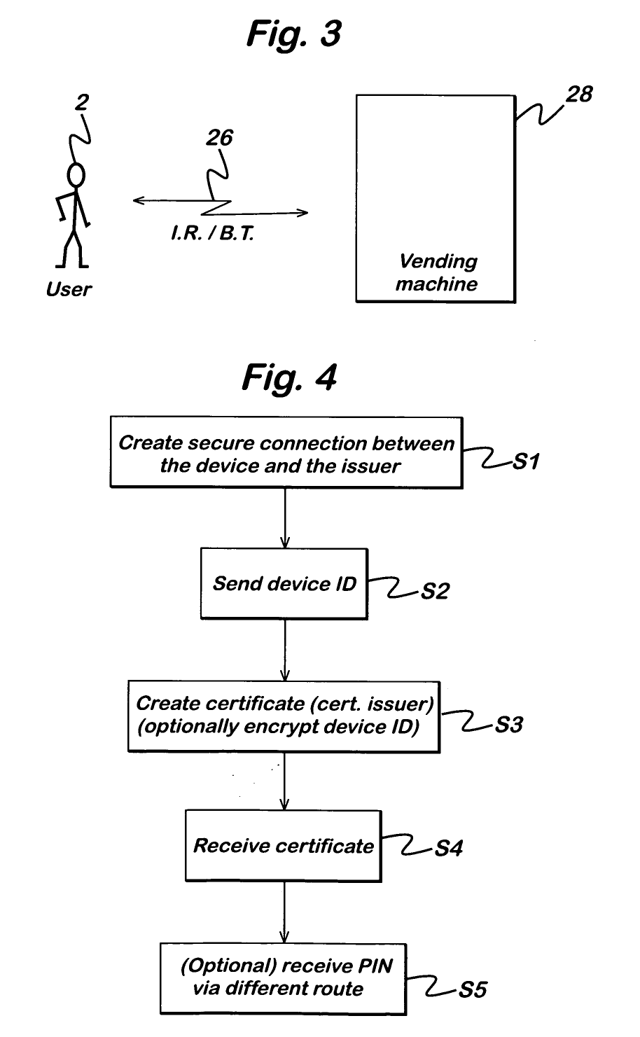

Once the certificate is downloaded and stored in the mobile terminal, then the user can use that certificate to purchase goods or services. Referring to FIG. 3, an example is shown where the user 2 purchases goods from a vending machine 28. It should be appreciated that embodiments of the present invention can be used with any suitable point of sale terminal or the like.

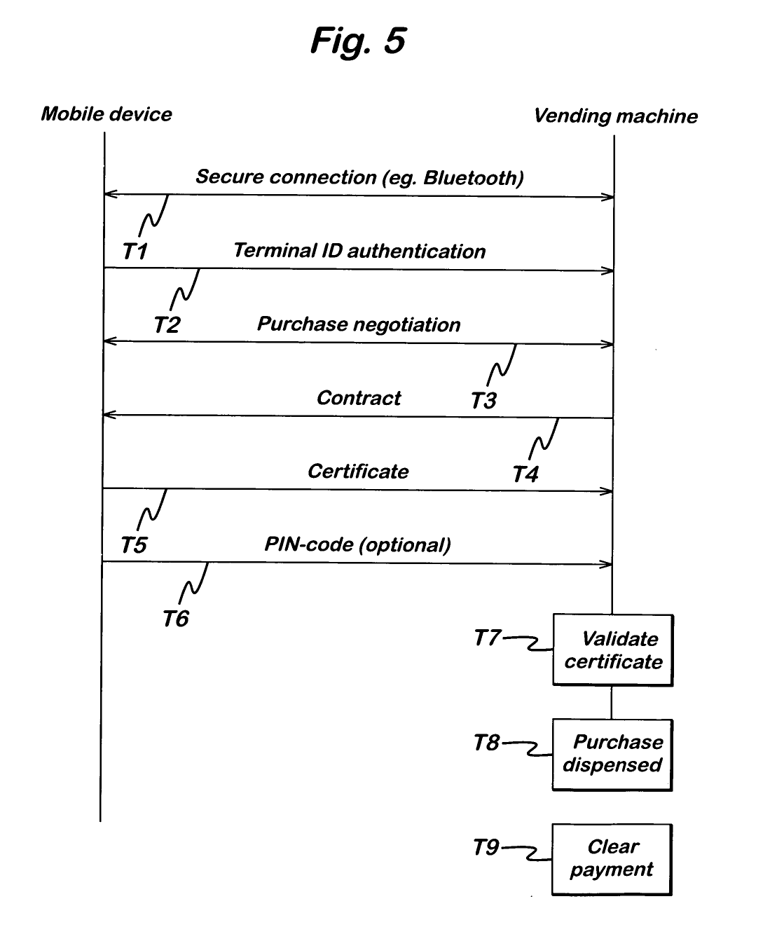

Reference will now be made to FIG. 5 which illustrates the steps taken to purchase an item from a vending machine. In the preferred embodiments of the present invention, goods are purchased using the mobile terminal communicating with the vending machine 28 or the like via an infrared or Bluetooth link 26. This is set up in step T1. However, the link 26 can take any other suitable form such as by a radio frequency connection, or the like. In alternative embodiments of the present invention, the phone may even be plugged in or connected to the vending machine or the like by a wired connection. The connection is preferably a secure connection.

In step T2, the mobile terminal sends to the vending machine, the mobile terminal's 5 identity authentication. This may be part of step T1 in some embodiments of the invention.

In step T3, the mobile terminal associated with the user 2 negotiates a purchase with the vending machine 28. The negotiation of the purchase may include selecting goods and advising the user of the price. This step may also include the user confirming that he wishes to purchase one or more particular items.

Once the purchase has been confirmed, the vending machine in step T4 sends a contract to the terminal. This contract may indicate the purchase price, the item and ask for confirmation of this. It should be appreciated that steps T3 and T4 are arranged so as to avoid any repetition. In alternative embodiments of the present invention, the two steps may be combined.

In step T5 mobile terminal sends the certificate.

The vending machine will already have the Bluetooth or the like identity of the mobile terminal as this is provided when the Bluetooth or the like link is established between the mobile terminal and the vending device. Alternatively or additionally other identity information about the mobile terminal and/or the user may be provided.

In step T6(which is optional), the user enters the PIN code on the mobile terminal and that PIN is then sent to the vending device.

In step T7, the vending machine validates the certificate. In particular, software in the vending device can validate the certificate offline. The vending machine checks the date on the certificate and checks if the date is still valid. The vending device also compares the Bluetooth or the like identity on the certificate with the Bluetooth identity or like received separately from the mobile terminal. Finally, the vending device software optionally checks the PIN code of the user with the information contained on the certificate. The vending machine may be provided beforehand with the algorithm from the bank or the like. The algorithm uses information contained in the certificate to determine what the PIN code should be. If the certificate is validated, then the purchase is dispensed in step T8 and the vending machine stores information relating to the certificate and the value of the purchase.

The information stored in the vending device can be downloaded periodically to a controller, the merchant's server or the like via a wired connection. Alternatively, a service man can visit the vending machine periodically and download the information from that machine wired a wired or wireless connection. This allows the payment to be cleared and this is step T9.

In summary, in preferred embodiments of the invention, the certificate is provided to the mobile device by for example a bank. The certificate contains device identity, the user identity (the card, certificate or other like identity) and the period for which the certificate is valid. When the mobile device is used to make a payment, the mobile device sends to for example a vending machine or the like, the device identity, the certificate and optionally the user entered PIN code. When validating the certificate, the vending machine checks the validity period, the device identity sent separately with the device identity in the certificate, and optionally the PIN code entered by the user with the PIN code derived from the certificate information using a previously provided algorithm.

Embodiments of the invention mean that a user can make purchases using a mobile phone in an offline environment in a secured way. In offline mobile e-commerce environments, it can be difficult to authenticate the user in a simple way. Embodiments of the present invention are able to overcome this in that the users certificate is tied to the user device and optionally the user PIN so that the vending machine, point-of-sale terminal or the like can validate the user in a simple way and there are no security problems even if the users certificate is copied fraudulently. Embodiments of the present invention have safeguards in that not only does the user need the certificate, the certificate is specific to the user's device and optionally also to the user's PIN code. Since the certificate and the terminal are bound together this provides extra security to the user in a simple way. If the certificate is stolen and somebody tries to use it from another device, it will be useless. The device identity cannot easily be changed by the user and if the device identity is encrypted in the certificate and the certificate integrity is checked (using a known technique such as digital signatures) the certificate cannot be changed either.

What is claimed is:

1. A method for facilitating payments in a mobile device comprising providing the mobile device with a payment certificate, said payment certificate comprising identification information relating to said mobile device.

2. A method as claimed in claim 1, wherein said certificate is provided by any one of a:
credit agency; bank; and service provider.

3. A method as claimed in claim 1, wherein said identification information comprises one or more of the following:
Bluetooth identity, dialling number, device public key, international mobile station equipment identity.

4. A method as claimed in claim 1, wherein said certificate is only valid for a predetermined time.

5. A method as claimed in claim 4, wherein said certificate comprises information identifying said predetermined time.

6. A method as claimed in claim 1, comprising the step of transmitting said certificate to a third party.

7. A method as claimed in claim 6, comprising the step of transmitting said identification information as well as said certificate to said third party.

8. A method as claimed in claim 7, wherein said identification information is sent to said third party when a connection is set up between said third party and the device.

9. A method as claimed in claim 6, comprising the step of transmitting a PIN code to said third party.

10. A method as claimed in claim 9, wherein said PIN code is derived from at least one piece of information contained in said certificate.

11. A method as claimed in claim 6, wherein the third party is arranged to validate the certificate.

12. A method as claimed in claim 7, wherein the third party is arranged to validate the certificate and wherein said certificate is validated by comparing the identification contained in said certificate with the identification information.

13. A method as claimed in claim 11, comprising the step of transmitting a PIN code to said third party and wherein said certificate is validated by comparing the identification contained in said certificate with the identification information and wherein said certificate is validated by the third party comparing the received PIN code with a PIN code generated by the third party.

14. A method as claimed in claim 13, wherein the PIN code generated by the third party uses information contained in said certificate.

15. A method as claimed in claim 6, wherein said third party comprises a vending machine or point of sale terminal.

16. A method for facilitating payments in a mobile device comprising providing the mobile device with a payment certificate said payment certificate containing information relating to said mobile device.

17. A method as claimed in claim 1, wherein said mobile device is a mobile telephone.

18. A payment system comprising a mobile device and a sale device, said mobile device and said sale device comprising means for establishing a connection therebetween, said mobile device being arranged to store a payment certificate comprising identification information relating to said device, said payment certificate being sent in use to said sale device, said sale device comprising means for validating the certificate and means for authorising a payment in dependence on the results of said validation by said validation means.

19. A mobile device for making a payment, said device comprising storage means, said storage means storing a payment certificate comprising information identifying said device.

20. A device as claimed in claim 19, wherein said certificate further comprises the time for which the information is valid.

21. A device as claimed in claim 19, wherein said identity information comprises at least one of the following:
Bluetooth identity, dialling number, device public key, international mobile station equipment identity.

22. A device as claimed in claim 19, wherein said device has connection means for receiving said payment certificate.

23. A device as claimed in claim 19, wherein said mobile device is a mobile telephone.
